(19) United States
(12) Patent Application Publication
(10) Pub. No.: US 2023/0245185 A1
(43) Pub. Date: Aug. 3, 2023

(54) ORDERING SYSTEM AND WEIGHT MEASURING DEVICE

(71) Applicant: KYOCERA Corporation, Kyoto (JP)

(72) Inventors: Hideki MORITA, Yokohama-shi, Kanagawa (JP); Masanao SEKINE, Kawasaki-shi, Kanagawa (JP); Yasuhiro UENO, Yokohama-shi, Kanagawa (JP); Tatsuya FUKUSHIGE, Yokohama-shi, Kanagawa (JP)

(73) Assignee: KYOCERA Corporation, Kyoto (JP)

(21) Appl. No.: 18/002,805

(22) PCT Filed: Jun. 3, 2021
(86) PCT No.: PCT/JP2021/021246

§ 371 Date: Dec. 21, 2022

(30) Foreign Application Priority Data
Jun. 26, 2020 (JP) 2020-110746

(51) Int. Cl. G06Q 30/06; G06Q 10/08; G01G 23/37; G01G 19/52

(52) U.S. Cl. CPC G06Q 30/06; G06Q 10/08; G01G 23/3728; G01G 19/52

(57) ABSTRACT

In one aspect, an ordering system includes a weight measuring device configured to transmit weight data obtained by measuring a weight of a measurement target object to outside, and an ordering device configured to acquire the weight data transmitted by the weight measuring device. The ordering device includes a storage configured to store remaining amount data of the measurement target object, a calculator configured to adjust the remaining amount data based on the weight data when the weight data is decreased compared with the remaining amount data and not to adjust the remaining amount data when the weight data is increased compared with the remaining amount data, and an orderer configured to execute processing related to ordering of the measurement target object based on the remaining amount data.

### TECHNICAL FIELD

The present application relates to an ordering system and a weight measuring device.

### BACKGROUND OF INVENTION

For example, Patent Document 1 discloses managing the remaining amount of an article that changes with the use of the article, controlling the stock of the article to keep the article ready for use, reflecting remaining amount data obtained by management of the remaining amount in management of stock, and placing an order for the article based on the management stock.

### CITATION LIST

### Patent Literature

Patent Document 1: JP 2005-112499 A

### SUMMARY

### Problem to be Solved

In a known technique, when variations occur in weight data used for ordering, there is a possibility that the remaining amount cannot be accurately managed and the article may be erroneously ordered. Therefore, in the known technique, there is room for improvement in the accuracy of ordering based on the weight data.

### Solution to Problem

In one aspect, an ordering system includes a weight measuring device configured to transmit weight data obtained by measuring a weight of a measurement target object to outside, and an ordering device configured to acquire the weight data transmitted by the weight measuring device. The ordering device includes a storage configured to store remaining amount data of the measurement target object, a calculator configured to adjust the remaining amount data based on the weight data when the weight data is decreased compared with the remaining amount data and not to adjust the remaining amount data when the weight data is increased compared with the remaining amount data, and an orderer configured to execute processing related to ordering of the measurement target object based on the remaining amount data.

In one aspect, a weight measuring device includes a weight sensor configured to measure weight data of a measurement target object, a storage configured to store remaining amount data of the measurement target object, a calculator configured to adjust the remaining amount data based on the weight data when the weight data is decreased compared with the remaining amount data and not to adjust the remaining amount data when the weight data is increased compared with the remaining amount data, and an orderer configured to execute processing related to ordering of the measurement target object based on the remaining amount data.

In one aspect, a weight measuring device includes a weight sensor configured to measure weight data of a measurement target object, a storage configured to store remaining amount data of the measurement target object, a detector configured to detect a use operation on the measurement target object, and a calculator configured to determine according to the use operation detected whether or not to adjust the remaining amount data based on the weight data measured by the weight sensor.

### BRIEF DESCRIPTION OF THE DRAWINGS

FIG. 1 is a diagram illustrating an example of an outline of an ordering system according to an embodiment.

FIG. 2 is a diagram illustrating an example of changes in remaining amount data according to an embodiment.

FIG. 3 is a perspective view of a weight measuring device according to an embodiment as viewed from the front side.

FIG. 4 is a perspective view of a weight measuring device according to an embodiment as viewed from the back side.

FIG. 5 is a perspective view of a weight measuring device on which a measurement target object is placed as viewed from the front side.

FIG. 6 is a perspective view illustrating the weight measuring device illustrated in FIG. 3 with a tray removed.

FIG. 7 is an exploded view of the weight measuring device illustrated in FIG. 3.

FIG. 8 is a perspective view of a communicator placement portion in the weight measuring device illustrated in FIG. 4.

FIG. 9 is a block diagram illustrating a device configuration of a weight measuring device according to an embodiment.

FIG. 10 is a flowchart showing a flow of operations when measuring weight with a weight measuring device according to an embodiment.

FIG. 11 is a block diagram illustrating an example of a functional configuration of an ordering device according to an embodiment.

FIG. 12 is a flowchart showing an example of a processing procedure by a controller of the ordering device.

FIG. 13 is a flowchart showing a variation of the processing procedure by the controller of the ordering device.

FIG. 14 is a block diagram illustrating a device configuration of a weight measuring device according to a variation of an embodiment.

FIG. 15 is a flowchart showing an example of a processing procedure by a controller of the weight measuring device.

FIG. 16 is a block diagram illustrating a device configuration of a weight measuring device according to another variation of an embodiment.

FIG. 17 is a flowchart showing an example of a processing procedure by a controller of the weight measuring device according to another variation of an embodiment.

### DESCRIPTION OF EMBODIMENTS

### Embodiments

A plurality of embodiments for implementing an ordering system and a weight measuring device according to the present application will be described in detail with reference to the drawings. Note that the present application is not limited by the following descriptions, Constituent elements in the following descriptions include those that can be easily assumed by a person skilled in the art, those that are substantially identical to the constituent elements, and those within a so-called range of equivalents. In the following descriptions, the same reference signs may be assigned to the same constituent elements. Further, redundant descriptions may be omitted.

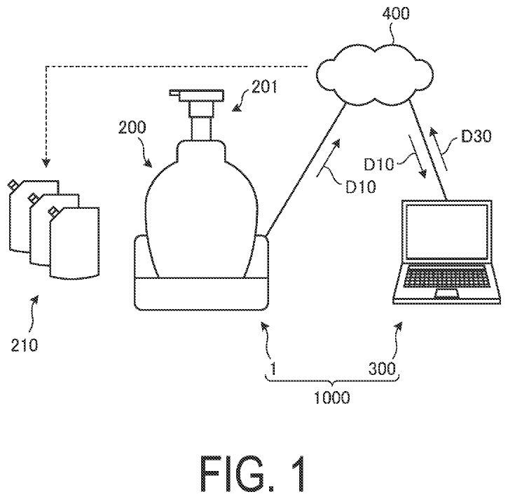

FIG. 1 is a diagram illustrating an example of an outline of an ordering system according to an embodiment. The example illustrated in FIG. 1 illustrates an example of a system configuration in which an ordering system 1000 manages a remaining amount of a measurement target object used by a user and automatically places an order for the measurement target object based on the remaining amount. The present application describes a case in which the measurement target object is hand soap, but is not limited to this case. The measurement target object includes consumer goods consumed by a user. For example, the measurement target object includes liquid consumer goods contained in a container such as a detergent, a disinfectant solution, a medical agent, a chemical agent, a cosmetic product, a beverage, and an oil. For example, the consumer goods may include consumables in the form of a powder, solid, gel, foam, and the like whose weight is measurable.

The ordering system 1000 includes a weight measuring device 1, and an ordering device 300. The weight measuring device 1 is configured to enable placement of a measurement target object 200 thereon and to measure the weight of the measurement target object 200. The ordering device 300 is configured to acquire weight data D10 of the measurement target object 200 measured by the weight measuring device 1 and automatically place an order for the measurement target object 200 based on the weight data D10. The weight measuring device 1 and the ordering device 300 are configured to communicate with each other via a communication network 400.

For ease of explanation, the present disclosure describes a case in which the weight measuring device 1 and the ordering device 300 cooperate with each other on a one-to-one basis in the ordering system 1000, but is not limited to this case. For example, the ordering device 300 may be configured to manage the remaining amount of the measurement target object 200 for each of a plurality of weight measuring devices 1.

The weight measuring device 1 measures the weight of the measurement target object 200 with a load sensor at a predetermined timing. The predetermined timing includes, for example, a preset timing, and a timing at which an operation on the measurement target object 200 is detected. The weight measuring device 1 transmits the weight data D10 indicating a measured weight to the ordering device 300 via the communication network 400, The weight data D10 includes, for example, data indicating an ID of the measurement target object 200 or a user, a weight, and the like.

When the measurement target object 200 is hand soap, the hand soap can be typically pushed out from a container for use by a pumping action caused by a user pushing a push portion 201 of the container. For example, the weight measuring device 1 can measure the weight data D10 with a weight sensor 30 at a timing at which the measurement target object 200 is not used by a user, instead of constantly measuring the weight of the measurement target object 200.

Upon receipt of the weight data D10 from the weight measuring device 1, the ordering device 300 calculates a difference between the weight data D10 and remaining amount data being managed. The remaining amount data includes, for example, data indicating a remaining amount (weight) of the measurement target object 200. For example, when the measurement target object 200 is used by a user, the weight data D10 is decreased compared with the remaining amount data. On the other hand, when the measurement target object 200 is not used by a user, the weight data D10 matches the remaining amount data. Thus, when the weight data D10 is decreased compared with the remaining amount data, the ordering device 300 adjusts the remaining amount data based on the weight data D10. On the other hand, when the weight data D10 is increased compared with the remaining amount data, there is a possibility that a fluctuation in the weight sensor of the weight measuring device 1 causes a variation in the measurement result. Thus, when the weight data D10 is increased compared with the remaining amount data, the ordering device 300 does not adjust the remaining amount data.

The ordering device 300 executes processing related to ordering of the measurement target object 200 based on the remaining amount data. For example, the ordering device 300 executes the processing related to ordering of the measurement target object 200 when the remaining amount data is smaller than an ordering threshold value. The ordering threshold value includes, for example, a threshold value set by a user or the like, and a threshold value based on a decrease ratio of the measurement target object 200. The processing related to ordering includes, for example, a process ordering the measurement target object 200 from a supply source, a preset supplier, or the like via the communication network 400, a process of calculating the amount of the measurement target object 200 to be ordered, and a process of setting a delivery destination of the measurement target object 200.

Through the execution of the processing related to ordering, the ordering device 300 creates order data D30 indicating an order for the measurement target object 200, and transmits the order data D30 to an ordering destination via, the communication network 400. Accordingly, the ordering system 1000 can cause a refill 210 of the measurement target object 200 to be delivered to a user of the measurement target object 200. The refill 210 includes, for example, a new measurement target object 200, and an object to replenish the measurement target object 200. In the example illustrated in FIG. 1 where the measurement target object 200 is hand soap, the refill 210 is a refill of the hand soap. In the example illustrated in FIG. 1, the ordering device 300 places an order for three refills 210, but the order amount is not limited thereto.

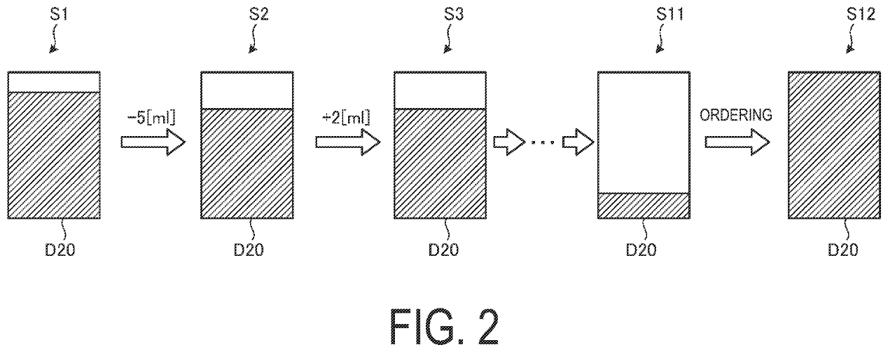

FIG. 2 is a diagram illustrating an example of changes in remaining amount data according to an embodiment. As illustrated in FIG. 2, in step S1, the ordering device 300 manages remaining amount data D20 indicating the remaining amount of the measurement target object 200 in an initial state. In this state, upon acquisition of the weight data D10 indicating that 5 [ml] of the measurement target object 200 has been used from the weight measuring device 1. the ordering device 300 decreases (adjusts) the remaining amount data D20 based on the weight data D10 because the weight data D10 has decreased compared with the remaining amount data D20.

In step S2, the ordering device 300 manages the remaining amount data D20 reflecting the difference of −5 [ml]. In this state, the ordering device 300 acquires the weight data D10 indicating that the measurement target object 200 has been increased by +2 [ml] compared with the remaining amount data D20 from the weight measuring device 1. In this case, the weight measuring device 1 measures the weight data D10 that has been increased due to the occurrence of a fluctuation in the weight sensor or the like, and transmits the weight data D10 to the ordering device 300. Thus, the ordering device 300 does not adjust the remaining amount data D20 because the weight data D10 is increased compared with the remaining amount data D20.

In step S3, since the ordering device 300 does not adjust the remaining amount data D20, the ordering device 300 manages the remaining amount data D20 indicating a remaining amount identical to the remaining amount in step S2. Similarly afterward, the ordering device 300 adjusts the remaining amount data D20 based on the weight data D10 when the weight data D10 is decreased compared with the remaining amount data D20. The ordering device 300 does not adjust the remaining amount data D20 when the weight data D10 is increased compared with the remaining amount data D20.

Then, in step S11, as a result of the adjustment of the remaining amount data D20 by the ordering device 300, the remaining amount data D20 becomes smaller than the ordering threshold value. The ordering device 300 transmits the order data D30 to an ordering destination via the communication network 400, and reflects an order amount ordered in the remaining amount data D20. In step S12, the ordering device 300 manages the remaining amount data D20 reflecting the order amount of the refill 210.

In this manner, the ordering system 1000 can manage the remaining amount of the measurement target object 200 without being affected by a fluctuation in the weight measuring device 1 or the like because the ordering device 300 does not adjust the remaining amount data when the weight data D10 from the weight measuring device 1 is increased compared with the remaining amount data. Accordingly, the ordering system 1000 can suppress the ordering device 300 from erroneously placing an order, and thus can improve the accuracy of ordering based on the weight data D10.

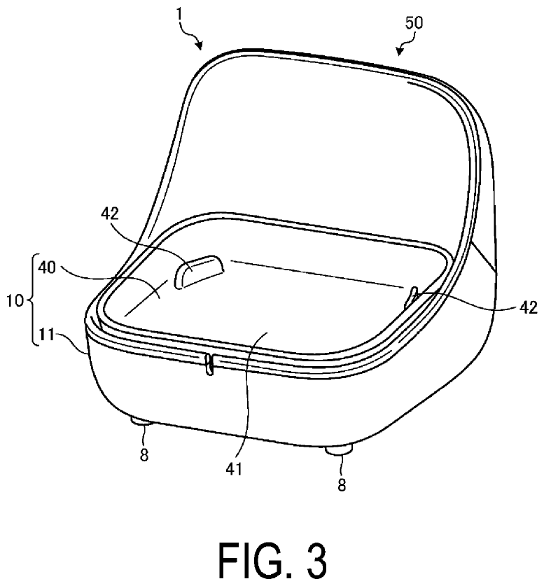

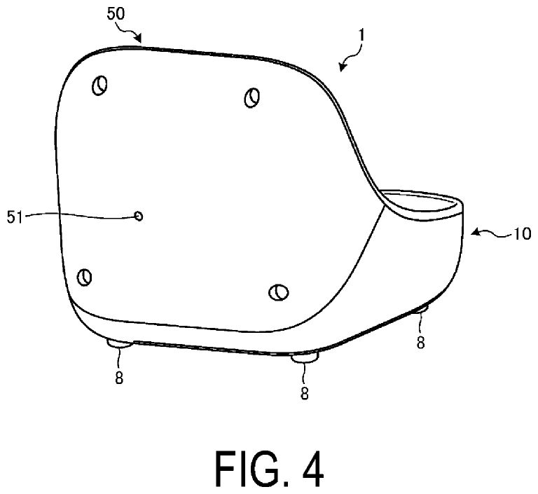

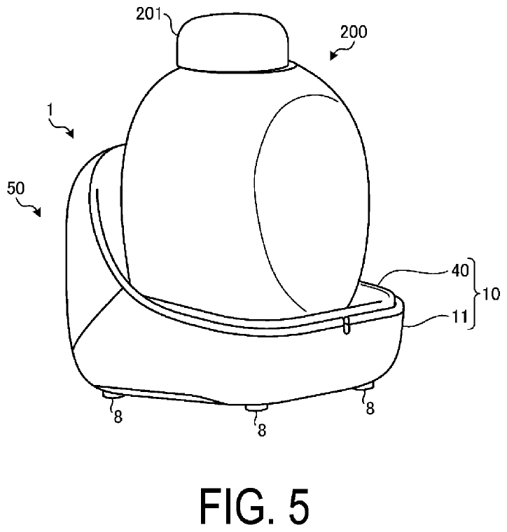

An example of the weight measuring device 1 in the ordering system 1000 illustrated in FIG. 1 will be described. FIG. 3 is a perspective view of the weight measuring device 1 according to an embodiment as viewed from the front side. FIG. 4 is a perspective view of the weight measuring device 1 according to an embodiment as viewed from the back side. FIG. 5 is a perspective view of the weight measuring device 1 on which the measurement target object 200 is placed as viewed from the front side. In FIG. 5, the push portion 201 of the measurement target object 200 is simplified.

In the present embodiment, the weight measuring device 1 can measure the weight of the measurement target object 200 placed on the weight measuring device 1 and transmit the measurement value of the measured weight to an external device by wireless communication. The weight measuring device 1 includes a weight measurer 10 and a communicator placement portion 50. The weight measurer 10 can have the measurement target object 200 placed thereon and measure the weight of the measurement target object 200. The communicator placement portion 50 is formed toward the upper side from the weight measurer 10, and a communication module 60) to be described later is disposed inside the communicator placement portion 50.

In the present embodiment, the weight measurer 10 is formed in a substantially rectangular shape having arc-shaped corners as viewed in the vertical direction. The communicator placement portion 50 is formed by extending toward the upper side from one side of a rectangle that is the shape of the weight measurer 10. In contrast, among the four sides of the rectangle that is the shape of the weight measurer 10, the three sides excluding the side on which the communicator placement portion 50 is disposed are open on the upper side.

The weight measurer 10 includes a weight measurer body 11 including a weight sensor 30 to be described later, and a tray 40 that is a placement portion on which the measurement target object 200 is placed. The weight measurer body 11 is a base portion of the weight measurer 10 and formed in a substantially rectangular shape having arc-shaped corners as viewed in the vertical direction. A plurality of rubber legs 8 are disposed on the lower side surface of the weight measurer body 11, each of the rubber legs 8 being a member provided with a rubber material and serving as a leg of the weight measuring device 1. The communicator placement portion 50 formed extending toward the upper side from one side of the weight measurer 10 is formed toward the upper side from the weight measurer body 11.

The tray 40 is formed in a substantially rectangular shape having arc-shaped corners as viewed in the vertical direction, the same as, and/or similar to the shape of the weight measurer 10 as viewed in the vertical direction. Also, the tray 40 is formed in a shape such that the outer periphery thereof rises toward the upper side. Accordingly, the tray 40 is formed in a shape capable of holding an object placed on the tray 40.

The tray 40 is disposed on the upper side of the weight measurer body 11, and is removable from the weight measurer body 11. The measurement target object 200 to be measured by the weight measuring device 1 is placed on the tray 40 included in the weight measurer 10 at the time of weight measurement. A holding member 42 holding the measurement target object 200 is formed on an upper surface 41 of the tray 40 on which the measurement target object 200 is placed. When the measurement target object 200 is placed on the weight measurer 10, the communicator placement portion 50 formed toward the upper side from the weight measurer 10 overlaps with the measurement target object 200 in the horizontal direction.

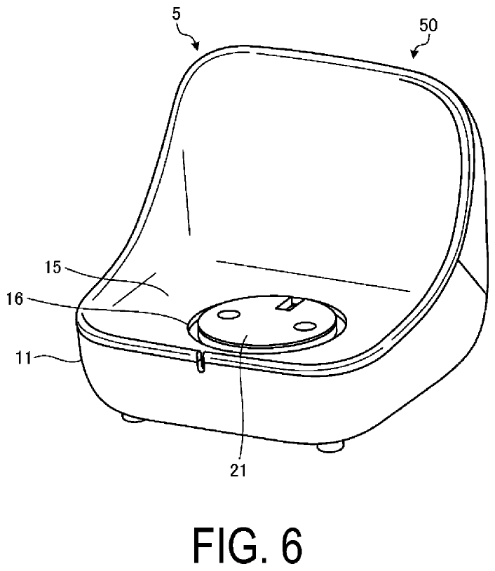

FIG. 6 is a perspective view illustrating the weight measuring device 1 illustrated in FIG. 3 with the tray 40 removed. The tray 40 (see FIG. 3) is removable from the weight measurer body 11. Portions of the weight measuring device 1 other than the tray 40 constitute a body 5 of the weight measuring device 1. That is, the weight measuring device 1 includes the body 5 and the tray 40 that is removable from the body 5. Specifically, a tray receiver 21 is disposed on an upper surface 15 side of the weight measurer body 11. The tray 40 is removable from the tray receiver 21. The tray receiver 21 is formed in a substantially circular shape as viewed in the vertical direction, and is disposed near the center of the upper surface 15 of the weight measurer body 11.

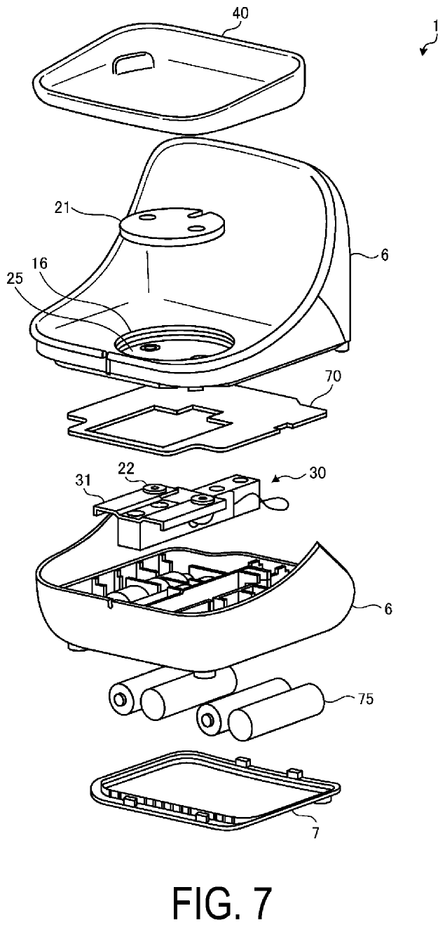

FIG. 7 is an exploded view of the weight measuring device 1 illustrated in FIG. 3, The weight measuring device 1 includes a housing 6, the tray 40, the tray receiver 21, a substrate 70, and the weight sensor 30. The housing 6 continuously forms the outline of the weight measurer 10 and the communicator placement portion 50. The substrate 70 and the weight sensor 30 are disposed inside a portion forming the weight measurer 10 in the housing 6. The weight sensor 30 is a means for detecting weight when the weight of the measurement target object 200 is measured with the weight measuring device 1. In the present embodiment, a so-called load cell that converts a detected load into an electrical signal and outputs the electrical signal is used as the weight sensor 30. The weight sensor 30 can measure the weight of the measurement target object 200 placed on the tray 40 by detecting the load received by the tray 40.

Specifically, the tray receiver 21 can be mounted on the weight sensor 30, and the tray 40 can be mounted on the tray receiver 21. Thus, the weight sensor 30 can receive the load received by the tray 40 via the tray receiver 21. Accordingly, the weight sensor 30 can measure the weight of the measurement target object 200 placed on the tray 40. That is, the tray 40, which is a placement portion on which the measurement target object 200 is placed, transmits the load from the measurement target object 200 placed on the tray 40 to the weight sensor 30, and the weight sensor 30 measures the load transmitted from the tray 40 to measure the weight of the measurement target object 200.

The substrate 70 includes wiring of an electrical circuit through which electric power and electric signals in the weight measuring device 1 flow. The weight sensor 30 is electrically connected to the substrate 70. in the present embodiment, the weight measuring device 1 uses a battery 75, which is commercially-available, as a power supply. A plurality of batteries 75 is used, and the plurality of batteries 75 is disposed inside the weight measurer body 11. A battery lid 7, which is a lid to be detached when the batteries 75 are placed in and taken out of the weight measurer body 11, is disposed on a lower surface of the weight measurer body 11.

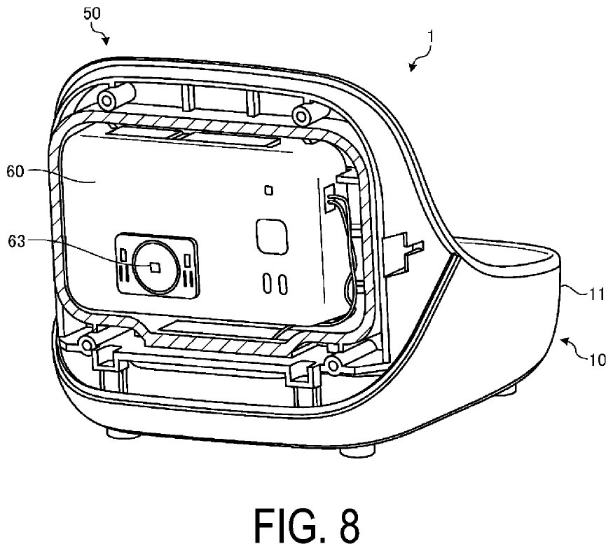

FIG. 8 is a perspective view of the communicator placement portion 50 in the weight measuring device 1 illustrated in FIG. 4. The communication module 60, which is a communicator that transmits a measurement value of the weight of the measurement target object 200 measured by the weight measurer 10, is disposed inside the communicator placement portion 50. The communication module 60 is a module that performs wireless communication, and can transmit and receive any information by wireless communication using radio waves that are carrier waves. In the present embodiment, the communication module 60 can transmit a weight measurement value measured by the weight sensor 30 by wireless communication.

For example, a wireless communication standard such as a communication standard including LTE Cat. M1 (Category M1) is applied to the communication module 60. The wireless communication standard to be applied to the communication module 60 is preferably set in accordance with the usage pattern of the weight measuring device 1, or the like. The weight measuring device 1 transmits a weight measurement value measured by the weight sensor 30 through wireless communication by the communication module 60 to convey the weight measurement value of the measurement target object 200 to an external device (not illustrated) managing the measurement target object 200. In this case, the external device managing the measurement target object 200 is, for example, the ordering device 300 that determines the necessity of the replenishment of the measurement target object 200 based on the weight measurement value of the measurement target object 200.

The communication module 60 includes, on the back side thereof, a calibration switch 63 that is a switch fir calibrating the weight measuring device 1. Calibration of the weight measuring device 1 is performed by pushing a thin rod-like object into a calibration switch hole 51 (see FIG. 4) formed on the hack side of the communicator placement portion 50.

The communication module 60 is disposed such that the position of the communication module 60 in the vertical direction is located on the upper side of the weight measurer 10. Thus, the position of the communication module 60 in the vertical direction is located on the upper side of the tray 40 included in the weight measurer 10.

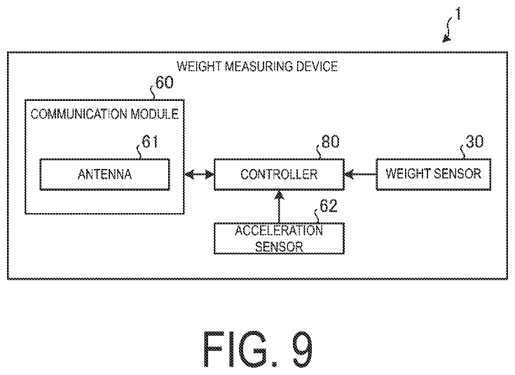

FIG. 9 is a block diagram illustrating a device configuration of the weight measuring device 1 according to an embodiment. The weight measuring device 1 includes the weight sensor 30 disposed in the weight measurer 10, the communication module 60 disposed in the communicator placement portion 50, an acceleration sensor 62, and a controller 80.

The controller 80 is an arithmetic processing unit including, for example, a central processing unit (CPU), a system-on-a-chip (SoC), a micro control unit (MCU), a field-programmable gate array (FPGA), and a coprocessor. The controller 80 loads a stored program into a memory and executes an instruction included in the program. The controller 80 includes an internal memory (not illustrated), and the internal memory is used for temporary storage of data in the controller 80.

The communication module 60 includes an antenna 61. The antenna 61 is a portion that transmits and receives radio waves when the communication module 60 transmits and receives information using radio waves. The communication module 60 converts information transmitted from the controller 80 into signals that can be transmitted from the antenna 61, and transmits the signals as radio waves from the antenna 61. The antenna 61 is integrally formed with the communication module 60, and the communication module 60 is disposed such that the position of the communication module 60 in the vertical direction is located on the upper side of the weight measurer 10. Thus, the antenna 61 is also disposed such that the position of the antenna 61 in the vertical direction is located on the upper side of the weight measurer 10, and on the upper side of the tray 40 included in the weight measurer 10.

The acceleration sensor 62 is an acceleration detector configured to detect the direction and the magnitude of an acceleration acting on the communication module 60, that is, an acceleration acting on the weight measuring device 1. In the present embodiment, the acceleration sensor 62 is a triaxial acceleration sensor 62 configured to detect accelerations in three axis directions orthogonal to each other. The acceleration sensor 62 can be of a micro electro mechanical systems (MEMS) type based on piezo resistance, capacitance, piezoelectric element (piezoelectricity), or thermal detection, a servo type in which a movable coil is moved and returned to the original position thereof by a feedback current, a strain gauge type, or the like. The acceleration sensor 62 outputs a detection result to the controller 80. The controller 80 can perform various types of control based on the detection result of the acceleration sensor 62. In the present embodiment, the acceleration sensor 62 is included in the substrate 70, but the mounting position of the acceleration sensor 60 is not limited. For example, the acceleration sensor 62 may be installed in the communication module 60.

In the present embodiment, the weight measuring device 1 has the configuration as described above, and an example of the effects thereof will be described below. The weight measuring device 1 is used with the measurement target object 200 placed on the tray 40 included in the weight measurer 10. For example, the measurement target object 200, whose weight changes with the use of the measurement target object 200, is used. In the present embodiment, so-called hand soap that is liquid soap stored in a container is used as the measurement target object 200, and the measurement target object 200 includes the container of the hand soap. Since the liquid soap stored in the container decreases with use, the weight of the measurement target object 200, which is hand soap, decreases. The weight measuring device 1 measures the weight of the measurement target object 200 that changes as described above, and transmits, by wireless communication, a measurement value to an external device managing the measurement target object 200.

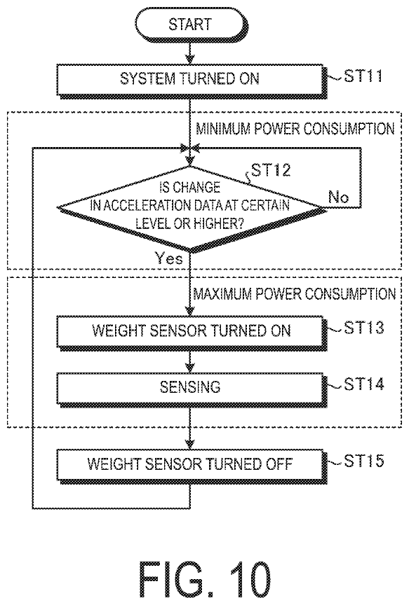

FIG. 10 is a flowchart showing a flow of operations when measuring weight with the weight measuring device 1 according to an embodiment. First, the system is turned on to use the weight measuring device 1 (step ST11). The system of the weight measuring device 1 is turned on, for example, by turning on a power switch (not illustrated) provided on the weight measuring device 1. When the system is turned on by operating a power switch or the like, the weight measuring device 1 can measure the weight of the measurement target object 200 using electrical power supplied from the battery 75 as a power supply. The hand soap, which is the measurement target object 200, may be placed on the tray 40 before the system is turned on, or may be placed on the tray 40 after the system is turned on.

In the weight measuring device 1, even when the system is turned on, the weight sensor 30 remains in an OFF state during standby in which the measurement target object 200 is not used. On the other hand, the acceleration sensor 62 operates by electrical power supplied from the battery 75 and detects acceleration transmitted to the acceleration sensor 62.

The controller 80 acquires acceleration data detected by the acceleration sensor 62 and determines whether or not the change in the acceleration data is at a certain level or higher (step ST12). The threshold value of the change in the acceleration data in this case is set in advance as a threshold value at which it can be determined that the push portion 201 of the measurement target object 200 has been pushed and the measurement target object 200 has been used, and is stored in the controller 80. The controller 80 compares the change in the acceleration data detected by the acceleration sensor 62 to the threshold value, and thereby determines whether or not the change in the acceleration data is at a certain level or higher.

When the change in the acceleration data is determined to be not at a certain level or higher (No in step ST12), the controller 80 continues to acquire the acceleration data detected by the acceleration sensor 62 and continues to determine whether or not the change in the acceleration data is at a certain level or higher.

On the other hand, when the change in the acceleration data is determined to be at a certain level or higher (Yes in step ST12), the controller 80 turns on the weight sensor 30 (step ST13). Then, the weight sensor 30 is operated by electrical power supplied from the battery 75.

The controller 80 uses the weight sensor 30, which has been turned on, to perform weight sensing (step ST14). That is, the weight sensor 30 measures the weight of the measurement target object 200 placed on the tray 40. The weight sensor 30 transmits a measurement value of weight to the controller 80, and the controller 80 transmits the weight data D10 indicating the measurement value of the weight of the measurement target object 200 to the external ordering device 300 managing the measurement target object 200 through the communication module 60. Accordingly, the weight measuring device 1 can transmit the weight data 1310 of the measurement target object 200 to convey the current remaining amount of the measurement target object 200 such as hand soap. which changes with use. As a result, the external ordering device 300 that has received the weight data D 10 can manage the remaining amount of the measurement target object 200.

Note that the timing of transmitting the measurement value of the weight of the measurement target object 200 transmitted from the weight measuring device 1 may be set as appropriate in accordance with the usage pattern and/or the management method of the measurement target object 200, for example, once a day during a time period in which the measurement target object 200 is not used, such as in the middle of the night.

When the change in the acceleration data is determined to be at a certain level or higher (Yes in step ST12), the controller 80 turns off the weight sensor 30 after a predetermined period of time has passed (step ST15). That is, when a predetermined period of time has passed after the measurement target object 200 is determined to have been used and a situation arises in which the weight of the measurement target object 200 can be determined to be no longer changed, the controller 80 turns off the weight sensor 30 and stops the measurement of the weight of the measurement target object 200.

After turning off the weight sensor 30, the controller 80 returns to step ST12 and determines whether or not the change in the acceleration data detected by the acceleration sensor 62 is at a certain level or higher.

The weight sensor 30 consumes a larger amount of electrical power than the acceleration sensor 62. Thus, when the weight sensor 30 is in the ON state (steps ST13 and ST14), the weight measuring device 1 consumes a large amount of electrical power. In contrast, when the weight sensor 30 is in the OFF state (step ST12), the weight measuring device 1 detects an acceleration with the acceleration sensor 62 with a small amount of electrical power consumption.

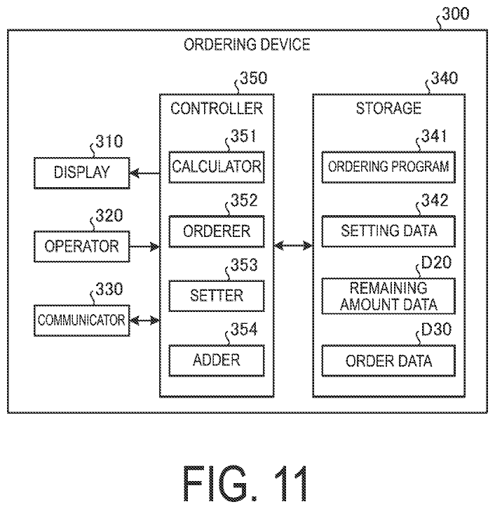

An example of the ordering device 300 of the ordering system 1000 illustrated in FIG. 1 will be described. FIG. 11 is a block diagram illustrating an example of a functional configuration of the ordering device 300 according to an embodiment. The ordering device 300 illustrated in FIG. 11 is implemented by, for example, a computer, an electronic device, or the like that executes a process of managing the measurement target object 200 in cooperation with the weight measuring device 1. The electronic device includes, for example, a smartphone, a tablet terminal, and an agent device. The present embodiment describes a case in which the ordering device 300 is a cloud server capable of communicating with the weight measuring device 1.

The ordering device 300 includes a display 310, an operator 320, a communicator 330, a storage 340, and a controller 350. The controller 350 is electrically connected to the display 310, the operator 320, the communicator 330, and the storage 340.

The display 310 is configured to be capable of displaying various types of data under the control of the controller 350. The display 310 includes, for example, a display panel such as a liquid crystal display and an organic electro-luminescence (EL) display.

The operator 320 includes one or more devices for receiving an operation of a user. The devices for receiving an operation of a user include, for example, a key, a button, and a touch screen. The operator 320 inputs a signal corresponding to a received operation to the controller 350.

The communicator 330 can communicate wirelessly. The communicator 330 supports a wireless communication standard. The wireless communication standard supported by the communicator 330 includes, for example, a communication standard for cellular phones such as 2G, 3G, 4G, 5G, or the like, and a near-field wireless communication standard. The communication standard for cellular phones includes, for example, Long Term Evolution (LTE), Wideband Code Division Multiple Access (W-CDMA), Worldwide Interoperability for Microwave Access (WiMAX; trade name), CDMA2000, Personal Digital Cellular (PDC), Global System for Mobile Communications (GSM; trade name), and Personal Handy-phone System (PHS). The near-field wireless communication standard includes, for example, IEEE802.11 (IEEE is an acronym for The Institute of Electrical and Electronics Engineers, Inc.), Bluetooth (trade name), Infrared Data Association (IrDA), Near Field Communication (NFC), and Wireless Personal Area Network (WPAN). A WPAN communication standard includes, for example, ZigBee (trade name), Digital Enhanced Cordless Telecommunications (DECT), Z-Wave, and Wireless Smart Utility Network (WiSUN). A communication standard for IoT includes a communication standard compliant with Low Power Wide Area (LPWA), for example, Long Range (LoRa; trade name), Long Range Wide Area Network (LoRaWAN; trade name). SIGFOX (trade name), Category NB1 (Cat.NB1), and Cat.M1. The communicator 330 may support one or more of the communication standards described above.

The storage 340 stores a program and data. The storage 340 is also used as a work area that temporarily stores the processing result of the controller 350. The storage 340 may include an arbitrary non-transitory storage medium such as a semiconductor storage medium, and a magnetic storage medium. The storage 340 may include a plurality of types of storage media. The storage 340 may include a combination of a portable storage medium such as a memory card, an optical disk, a magnet-optical disk, or the like and a device for reading the storage medium. The storage 340 may include a storage device used as a temporary storage region such as a random access memory (RAM).

The storage 340 stores, for example, data such as an ordering program 341 and setting data 342. The ordering program 341 can provide functions related to various types of controls for operating the ordering device 300. For example, the ordering program 341 controls the communicator 330 to establish communication with an electronic device such as the weight measuring device 1. The ordering program 341 includes programs causing the controller 350 (computer) to function as a calculator 351 and an orderer 352. The calculator 351 adjusts the remaining amount data D20 based on the weight data D10 when the weight data D10 is decreased compared with the remaining amount data D20 and does not adjust the remaining amount data D20 when the weight data D10 is increased compared with the remaining amount data D20. The orderer 352 executes the processing related to ordering of the measurement target object based on the remaining amount data D20.

The setting data 342 includes information about various types of settings related to ordering by the ordering device 300. The setting data 342 may include information about a user of the measurement target object 200. The setting data 342 may include the above-described ordering threshold value corresponding to the measurement target object.

The storage 340 can store the remaining amount data D20 and the order data D30 described above. The remaining amount data D20 includes data indicating the remaining amount of the measurement target object 200. The remaining amount data D20 is associated with various types of information related to a user who uses the measurement target object 200. In the present embodiment, the remaining amount data D20 includes, for example, an ID that can identify the weight measuring device 1 or an ordering destination, and information such as the remaining amount of the measurement target object 200.

The order data D30 includes data for placing an order for the measurement target object 200 or the refill 210 to replenish the measurement target object 200. For example, the order data D30 includes various types of information such as the number to be ordered, the amount to be ordered, and a delivery destination.

The storage 340 can store the weight data D10 acquired from the weight measuring device 1 in chronological order. The storage 340 can store the weight data D10 in association with information about the measurement target object 200 or a user who uses the measurement target object 200.

The controller 350 is a computation processing device. For example, the computation processing device includes, but is not limited to, a CPU, an SoC, an MCU, an FPGA, and a coprocessor. The controller 350 comprehensively controls the operation of the ordering device 300 to implement various types of functions.

Specifically, the controller 350 executes an instruction included in a program stored in the storage 340 while referring, as appropriate, to data stored in the storage 340. Then, the controller 350 controls functional units in accordance with the data and the instruction, and thereby implements various types of functions. For example, the functional units include, hut are not limited to, the display 310 and the communicator 330.

The controller 350 includes functional units such as the calculator 351, the orderer 352, a setter 353, and an adder 354. The controller 350 implements the calculator 351, the orderer 352, the setter 353, and the adder 354 by executing the ordering program 341.

The calculator 351 calculates the weight data D10 indicating the weight of the measurement target object 200 based on the weight data D10. The calculator 351 implements a function of making an adjustment to the remaining amount data D20 based on the weight data D10 when the weight data D10 is decreased compared with the remaining amount data D20. The calculator 351 implements a function of making no adjustment to the remaining amount data D20 when the weight data D10 is increased compared with the remaining amount data D20.

The orderer 352 implements a function of executing the above-described processing related to ordering of the measurement target object 200 based on the remaining amount data D20. The orderer 352 generates the order data D30 for ordering and transmits the order data D30 to an ordering destination. The orderer 352 may present the order data D30 to a user, an administrator, or the like of the measurement target object 200 to cause the user, the administrator, or the like to place an order. The orderer 352 has a function of managing the fact that an order based on the order data D30 has been confirmed. For example, upon receipt of a confirmation notification from an ordering destination of the order data D30, the orderer 352 stores the fact that the order has been confirmed.

The setter 353 implements a function of setting in the storage 340 the weight data D10 acquired at the start of using the measurement target object 200 as an initial value of the remaining amount data D20. For example, the setter 353 acquires a default weight data D10 of the measurement target object 200 from a supply source, a database, or the like, and sets the acquired weight data D10 as the remaining amount data D20. The setter 353 ma identify a type, a model, or the like of the measurement target object 200 to acquire a default remaining amount (volume). The setter 353 may be configured to cause a user, an administrator, or the like to set a default remaining amount of the measurement target object 200.

The adder 354 implements a function of adding an order amount of the measurement target object 200 ordered by the orderer 352 to the remaining amount data D20. For example, the adder 354 adds a confirmed order amount to the remaining amount data D20. For example, when a plurality of refills 210 are ordered, the adder 354 adds the total volume of the plurality of refills 210 to the remaining amount data D20. Accordingly, the ordering device 300 does not frequently execute an ordering process, and thus an increase in processing load can be suppressed.

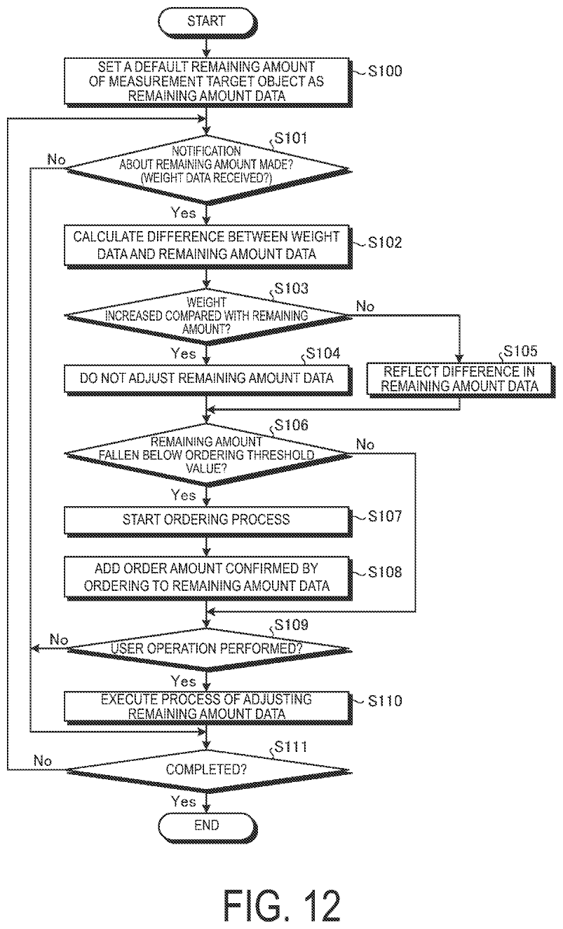

FIG. 12 is a flowchart showing an example of a processing procedure by the controller 350 of the ordering device 300. The processing procedure shown in FIG. 12 is implemented by the controller 350 executing the ordering program 341. The processing procedure shown in FIG. 12 is executed by the controller 350 at a predetermined timing. The predetermined timing includes, for example, a timing at which the management of the measurement target object 200 is started, and a timing at which the measurement target object 200 is placed on the weight measuring device 1.

As shown in FIG. 12, the controller 350 of the ordering device 300 sets a default remaining amount of the measurement target object 200 as the remaining amount data D20 (step S100). For example, the controller 350 acquires the default remaining amount such as volume information of the measurement target object 200 or a weight of the measurement target object 200 at the start of placement on the weight measuring device 1. and sets the acquired remaining amount as the remaining amount data D20. Upon completion of the process in step S100, the controller 350 causes the processing to proceed to step S101.

The controller 350 determines whether or not a notification about a remaining amount has been made (step S101). In other words, the controller 350 determines whether or not the weight data D10 has been received from the weight measuring device 1. For example, the controller 350 determines that the notification about the remaining amount has been made when the controller 350 has received the weight data D10 from the weight measuring device 1 via the communicator 330. For example, when the weight measuring device 1 transmits the weight data D10 once a day, the controller 350 determines that the notification about the remaining amount has been made once a day. When the controller 350 determines that the notification about the remaining amount has not been made (No in step S101), the controller 350 causes the processing to proceed to step S111 to be described later. When the controller 350 determines that the notification about the remaining amount has been made (Yes in step S101), the controller 350 causes the processing to proceed to step S102.

The controller 350 calculates a difference between the weight data D10 and the remaining amount data D20 (step S102). For example, the controller 350 calculates the difference by subtracting the remaining amount data D20 from the weight data D10, and stores the calculated difference in the storage 340. Upon completion of the process in step S102, the controller 350 causes the processing to proceed to step S103.

The controller 350 determines whether or not the weight has been increased compared with the remaining amount (step S103). For example, the controller 350 determines that the weight has been increased compared with the remaining amount when the difference calculated by subtracting the remaining amount from the weight in step S102 is a positive value. When the controller 350 determines that the weight has been increased compared with the remaining amount (Yes in step S103), the controller 350 causes the processing to proceed to step S104. The controller 350 does not adjust the remaining amount data D20 (step S104). That is, since there is a possibility that the weight data D10 from the weight measuring device 1 is affected by a fluctuation in the weight sensor 30 or the like, the controller 350 does not reflect the weight data D10 in the remaining amount data D20. Upon completion of the process in step S104, the controller 350 causes the processing to proceed to step S106 to be described later.

When the controller 350 determines that the weight has not been increased compared with the remaining amount (No in step S103), that is, the weight has been decreased compared with the remaining amount, the controller 350 causes the processing to proceed to step S105. The controller 350 reflects the difference in the remaining amount data D20 (step S105). For example, the controller 350 executes a process of subtracting the absolute value of the difference from the remaining amount data D20, setting the weight data D10 as the remaining amount data D20, or the like. This enables the controller 350 to adjust the remaining amount data D20 based on the weight data D10. Upon completion of the process in step S105, the controller 350 causes the processing to proceed to step S106.

The controller 350 determines whether or not the remaining amount has fallen below the ordering threshold value (step S106). For example, the controller 350 determines that the remaining amount has fallen below the ordering threshold value when the remaining amount value indicated by the remaining amount data D20 is smaller than the ordering threshold value of the setting data 342. When the controller 350 determines that the remaining amount has not fallen below the ordering threshold value (No in step S106), the controller 350 causes the processing to proceed to step S109 to be described later.

When the controller 350 determines that the remaining amount has fallen below the ordering threshold value (Yes in step S106), the controller 350 causes the processing to proceed to step S107. The controller 350 starts an ordering process (step S107). Starting the ordering process includes, for example, executing the ordering process. The ordering process includes, for example, a process of placing an order for the refill 210 of the measurement target object 200 via the communicator 330, and a process of placing an order for a new measurement target object 200 via the communicator 330. The ordering process includes, for example, a process of identifying the measurement target object 200 based on the ID of the weight data D 10 and thereby determining contents of an order. The ordering process includes, for example, a process of creating the order data D30 including information such as the contents of the order, a delivery destination, or the like. The ordering process includes, for example, a process of receiving a notification that the order has been confirmed from a transmission destination of the order data D30, and associating information indicating an order amount confirmed by the ordering with the order data D30. The ordering process includes, for example, a process of acquiring new weight data D10 after the ordering from the weight measuring device 1 as an order amount confirmed by the ordering. Upon completion of the ordering process, the controller 350 causes the processing to proceed to step S108.

The controller 350 adds the order amount confirmed by the ordering to the remaining amount data D20 (step S108). For example, the controller 350 reflects the result of the ordering in the remaining amount data D20 by adding a value of the order amount confirmed by the ordering to the remaining amount data D20. Upon completion of the process in step S108, the controller 350 causes the processing to proceed to step S109.

The controller 350 determines whether or not a user operation has been performed (step S109). For example, the controller 350 determines that a user operation has been performed when the controller 350 acquires adjustment operation information via the operator 320 or the communicator 330. When the controller 350 determines that no user operation has been performed (No in step S109), the controller 350 causes the processing to proceed to step Sill to be described later. When the controller 350 determines that a user operation has been performed (Yes in step S109), the controller 350 causes the processing to proceed to step S110.

The controller 350 executes an adjustment process of adjusting the remaining amount data D20 (step S110). The adjustment process includes, for example, a process of displaying an adjustment screen for adjusting the remaining amount data D20, and adjusting a remaining amount value indicated by the remaining amount data D20 according to an addition or a subtraction operation on the adjustment screen. The adjustment process includes, for example, a process of adjusting a remaining amount value indicated by the remaining amount data D20 based on adjustment information acquired by the controller 350. Upon completion of the adjustment process, the controller 350 causes the processing to proceed to step S111.

The controller 350 determines whether or not the processing procedure shown in FIG. 12 has been completed (step S111). For example, the controller 350 determines the completion of the processing procedure at a termination timing of the processing procedure. The termination timing includes, for example, a timing of termination of an ordering service, and a timing of generation of a termination request. When the controller 350 determines that the processing procedure has not been completed (No in step S111), the controller 350 returns the processing back to step S101 already described above and continues the processing procedure. When the controller 350 determines that the processing procedure has been completed (Yes in step S111), the controller 350 terminates the processing procedure shown in FIG. 12.

In the processing procedure shown in FIG. 12, the controller 350 functions as the setter 353 by executing the process in step S100. The controller 350 functions as the calculator 351 by executing the processes in step S102 to step S105. The controller 350 functions as the orderer 352 by executing the processes in step S106 to step S107. The controller 350 functions as the adder 354 by executing the process in step S108.

In the processing procedure shown in FIG. 12, the process in step S100 may be configured such that when the notification about the remaining amount of the measurement target object 200 is made from outside the ordering device 300, the notified value is set as the remaining amount data D20. Accordingly, the ordering device 300 can broaden available phases and/or products that can be used in the weight measuring device 1, thereby simplifying initial setting.

The ordering system 1000 can add the order amount of the measurement target object 200 ordered by the ordering device 300 to the remaining amount data D20. Accordingly, the order amount is reflected in the remaining amount data D20, and thereby the ordering device 300 can perform order management on the basis of an exact remaining amount even after the ordering. The need for a process of reflecting the order amount in the remaining amount data D20 is eliminated, and thereby the ordering device 300 can improve convenience. For example, even when an order is placed for an amount larger than the amount that can be contained in the measurement target object 200 (capacity of the measurement target object 200), the ordering device 300 can manage the remaining amount based on the weight of the measurement target object 200 in combination with a remaining amount in reserve.

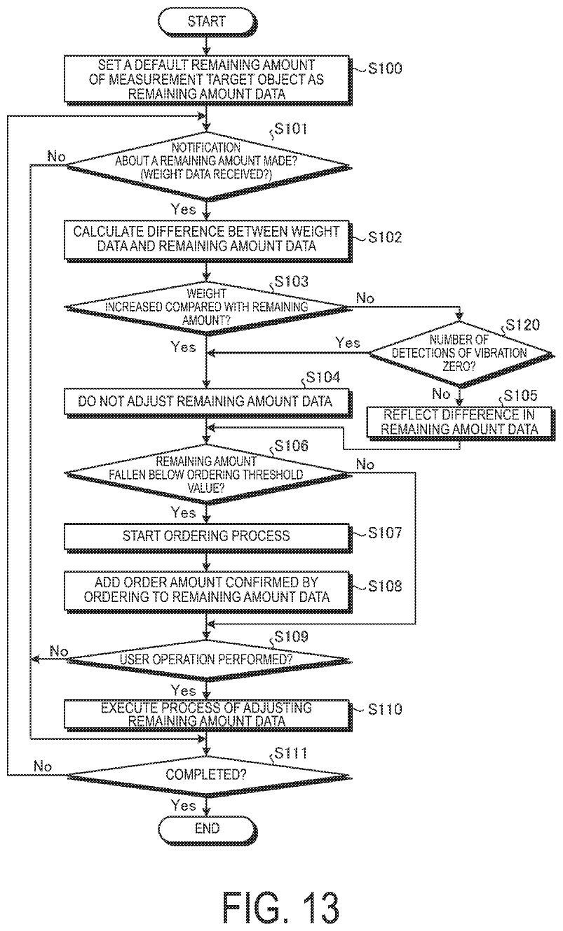

For example, a process for further improving the accuracy of the remaining amount data D20 can be added to the processing procedure shown in FIG. 12. FIG. 13 is a flowchart showing a variation of the processing procedure by the controller 350 of the ordering device 300. The processing procedure shown in FIG. 13 is implemented by the controller 350 executing the ordering program 341. The processing procedure shown in FIG. 13 is executed by the controller 350 at a predetermined timing.

The processes in step S100 to step S102 and step S104 to step S11 shown in FIG. 13 are identical to the processes in step S100 to step S102 and step S104 to step Sill shown in FIG. 12, and thus descriptions thereof are omitted.

As shown in FIG. 13, the controller 350 determines whether or not the weight has been increased compared with the remaining amount (step S103). When the controller 350 determines that the weight has been increased compared with the remaining amount (Yes in step S103), the controller 350 causes the processing to proceed to step S104. When the controller 350 determines that the weight has not been increased compared with the remaining amount (No in step S103), that is, the weight has been decreased compared with the remaining amount, the controller 350 causes the processing to proceed to step S120.

The controller 350 determines whether or not the number of detections of vibration is zero (step S120). For example, the controller 350 determines whether or not the number of detections of vibration is zero by detecting the number of detections of vibration according to an operation, on the basis of acceleration data acquired from the weight measuring device 1 via the communicator 330. When the controller 350 determines that the number of detections of vibration is zero (Yes in step S120), that is, the measurement target object 200 is highly unlikely to have been used, the controller 350 causes the processing to proceed to step S104 already described above. Accordingly, even when the weight has not been increased compared with the remaining amount, the controller 350 does not adjust the remaining amount data D20 because the measurement target object 200 has not been used. Upon completion of the process in step S104, the controller 350 executes the processes in step S106 and the subsequent steps.

When the controller 350 determines that the number of detections of vibration is not zero (No in step S120), that is, the measurement target object 200 is highly likely to have been used, the controller 350 causes the processing to proceed to step S105 already described above. The controller 350 reflects the difference in the remaining amount data D20 (step S105). Accordingly, the controller 350 can update the remaining amount data D20 according to the usage of the measurement target object 200, and thus the accuracy of the remaining amount data D20 can be improved. Upon completion of the process in step S105, the controller 350 executes the processes in step S106 and the subsequent steps as described above.

As described above, the ordering system 1000 adjusts the remaining amount data D20 on the basis of the weight data D10 when the number of detections of vibration is not zero, that is, when a criterion that an operation has been performed is satisfied. The ordering system 1000 does not adjust the remaining amount data D20 on the basis of the weight data D10 when the number of detections of vibration is zero, that is, when the criterion that an operation has been performed is not satisfied. Accordingly, the ordering system 1000 can determine whether or not to adjust the remaining amount data D20 based on the weight data D10, according to the change in the weight and the operation on the measurement target object 200. As a result, the ordering system 1000 can have an increased likelihood of preventing the ordering device 300 from erroneously placing an order, and thus can have a further improved accuracy in the ordering based on the weight data D10.

### Variations

In the above embodiments, the ordering system 1000 uses the weight measuring device 1 and the ordering device 300 to automatically place an order for the measurement target object 200, but is not limited thereto. The present variation describes an example of a case in which various types of functions of the ordering system 100 are implemented by the weight measuring device 1 described above.

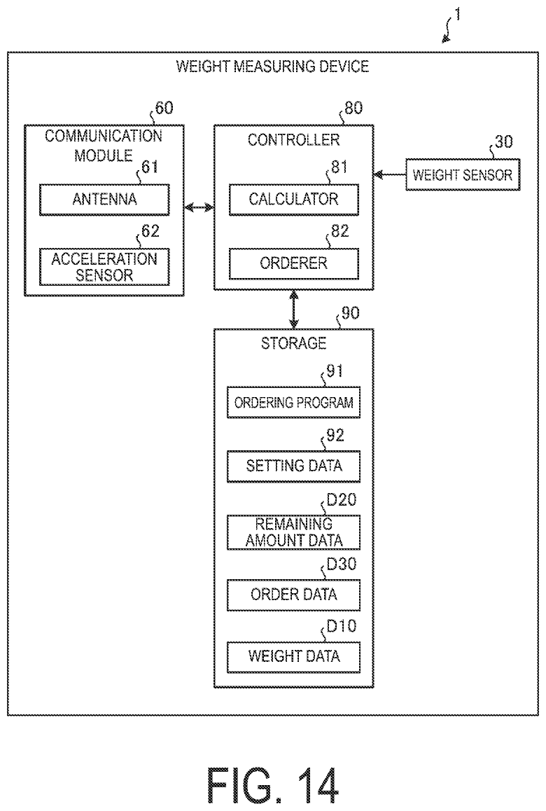

FIG. 14 is a block diagram illustrating a device configuration of the weight measuring device 1 according to a variation of an embodiment. The weight measuring device 1 includes the weight sensor 30 disposed in the weight measurer 10, the communication module 60 disposed in the communicator placement portion 50, the controller 80, and a storage 90.

The storage 90 stores a program and data. The storage 90 is also used as a work area that temporarily stores the processing result of the controller 80. The storage 90 may include an arbitrary non-transitory storage medium such as a semiconductor storage medium, and a magnetic storage medium. The storage 90 may include a plurality of types of storage media. The storage 90 may include a combination of a portable storage medium such as a memory card, an optical disc, a magnet-optical disk, or the like and a device for reading a storage medium. The storage 90 may include a storage device used as a temporary storage region such as a RAM.

The storage 90 stores, for example, data such as an ordering program 91 and setting data 92. The ordering program 91 can provide functions related to various types of controls for causing the weight measuring device 1 to perform an ordering operation. For example, the ordering program 91 controls the communication module 60 to establish communication with an external electronic device. The ordering program 91 includes programs causing the controller 80 (computer) to function as a calculator 81 and an orderer 82. The calculator 81 adjusts the remaining amount data D20 based on the weight data D10 when the weight data D10 is decreased compared with the remaining amount data D20 and does not adjust the remaining amount data D20 when the weight data D10 is increased compared with the remaining amount data D20. The orderer 82 executes processing related to ordering of the measurement target object 200 based on the remaining amount data D20.

The setting data 92 includes information about various types of settings related to ordering by the ordering device 300. The setting data 92 may include information about a user of the measurement target object 200. The setting data 92 may include the above-described ordering threshold value corresponding to the measurement target object.

The storage 90 can store the remaining amount data D20 and the order data D30 described above. The remaining amount data D20 includes data indicating the remaining amount of the measurement target object 200. The remaining amount data D20 is associated with various types of information related to a user who uses the measurement target object 200. The remaining amount data D20 includes, for example, an ID that can identify the weight measuring device 1 or an ordering destination, and information such as the remaining amount of the measurement target object 200.

The storage 90 can store the weight data D10 measured by the weight sensor 30 in chronological order. The storage 90 can store the weight data D10 in association with information about the measurement target object 200 or a user who uses the measurement target object 200.

The controller 80 executes an instruction included in a program stored in the storage 90 while referring, as appropriate, to data stored in the storage 90. Then, the controller 80 controls functional units in accordance with the data and the instruction, and thereby implements various types of functions. For example, the functional units include, but are not limited to, the display 310 and the communicator 330.

The controller 80 includes functional units of the calculator 81 and the orderer 82. The controller 80 implements the calculator 81 and the orderer 82 by executing the ordering program 91.

The calculator 81 calculates a difference between the weight data D10 and the remaining amount data D20. The calculator 81 implements a function of making an adjustment to the remaining amount data D20 based on the weight data D10 when the weight data D10 is decreased compared with the remaining amount data D20. The calculator 81 implements a function of making no adjustment to the remaining amount data D20 when the weight data D10 is increased compared with the remaining amount data D20.

The orderer 82 implements a function of executing the above-described processing related to ordering of the measurement target object 200 based on the remaining amount data D20. The orderer 82 generates the order data D30 for ordering and transmits the order data D30 to an ordering destination. The orderer 82 has a function of managing the fact that an order based on the order data D30 has been confirmed. For example, upon receipt of a confirmation notification from an ordering destination of the order data D30, the orderer 82 stores the fact that the order has been confirmed.

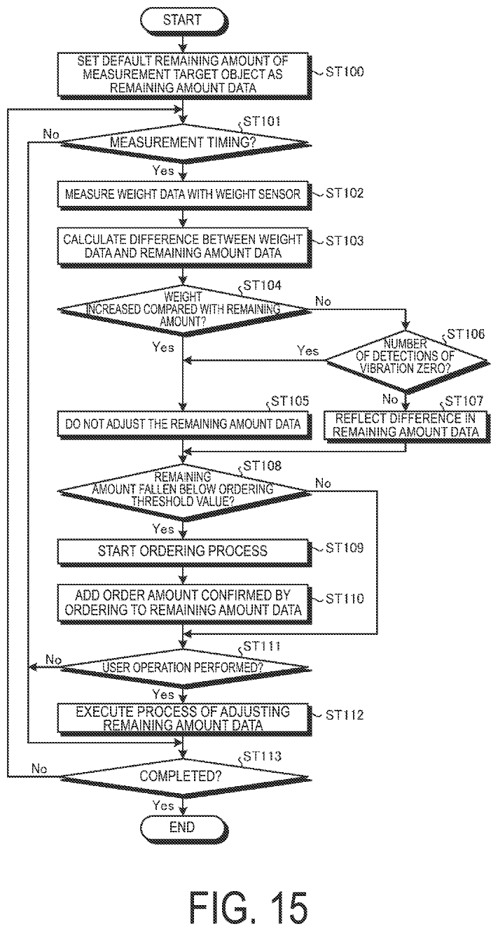

FIG. 15 is a flowchart showing an example of a processing procedure by the controller 80 of the weight measuring device 1. The processing procedure showing in FIG. 15 is implemented by the controller 80 executing the ordering program 91. The processing procedure shown in FIG. 15 is executed by the controller 80 at the predetermined timing described above.

As shown in FIG. 15, the controller 80 of the weight measuring device 1 sets a default remaining amount of the measurement target object 200 as the remaining amount data D20 (step ST100). For example, the controller 80 sets a default remaining amount such as volume information of the measurement target object 200 or a weight of the measurement target object 200 at the start of placement on the weight measuring device 1 as the remaining amount data D20. Upon completion of the process in step ST100, the controller 80 causes the processing to proceed to step ST101.

The controller 80 determines whether or not it is a measurement timing (step ST101). The controller 80 determines that it is a measurement timing, for example, when a time-out timing of a timer, a predetermined timing, an occurrence timing of a predetermined vibration, or the like is detected. When the controller 80 determines that it is not a measurement timing (No in step ST101), the controller 80 causes the processing to proceed to step ST113 to be described later. When the controller 80 determines that it is a measurement timing (Yes in step ST101), the controller 80 causes the processing to proceed to step ST102.

The controller 80 measures the weight data D10 with the weight sensor 30 (step ST102). For example, the controller 80 causes the weight sensor 30 to turn on and measure the weight of the measurement target object 200, and stores the weight data D10 in the storage 90. Upon completion of weight measurement, the controller 80 may cause the weight sensor 30 to turn off. Upon completion of the process in step ST102, the controller 80 causes the processing to proceed to step ST103.

The controller 80 calculates the difference between the weight data D10 and the remaining amount data D20 (step ST103). For example, the controller 80 calculates the difference by subtracting the remaining amount data D20 from the weight data D10, and stores the calculated difference in the storage 90. Upon completion of the process in step ST103, the controller 80 causes the processing to proceed to step ST104.

The controller 80 determines whether or not the weight has been increased compared with the remaining amount (step ST104). For example, the controller 80 determines that the weight has been increased compared with the remaining amount when the difference calculated by subtracting the remaining amount from the weight in step ST103 is a positive value. When the controller 80 determines that the weight has been increased compared with the remaining amount (Yes in step ST104), the controller 80 causes the processing to proceed to step ST105. The controller 80 does not adjust the remaining amount data D20 (step ST105). That is, since there is a possibility that the weight data D10 is affected by a fluctuation in the weight sensor 30 or the like, the controller 80 does not reflect the weight data D10 in the remaining amount data D20. Upon completion of the process in step ST105, the controller 80 causes the processing to proceed to step ST108 to be described later.

When the controller 80 determines that the weight has not been increased compared with the remaining amount (No in step ST104), that is, the weight has been decreased compared with the remaining amount, the controller 80 causes the processing to proceed to step ST106. The controller 80 determines whether or not the number of detections of vibration is zero (step ST106). For example, the controller 80 determines whether or not the number of detections of vibration is zero by detecting the number of detections of vibration according to an operation based on acceleration data measured by the acceleration sensor 62. When the controller 80 determines that the number of detections of vibration is zero (Yes in step ST106), that is, the measurement target object 200 is highly unlikely to have been used, the controller 80 causes the processing to proceed to step ST105 already described above. Accordingly, even when the weight has not been increased compared with the remaining amount, the controller 80 does not adjust the remaining amount data D20 because the measurement target object 200 has not been used (step ST105). Upon completion of the processing in step ST105, the controller 80 causes the processing to proceed to step ST108 to be described later.

When the controller 80 determines that the number of detections of vibration is not zero (No in step ST106), that is, the measurement target object 200 is highly likely to have been used, the controller 80 causes the processing to proceed to step ST107. The controller 80 reflects the difference in the remaining amount data D20 (step ST107). Accordingly, the controller 80 can update the remaining amount data D20 according to the usage of the measurement target object 200, and thus the accuracy of the remaining amount data D20 can be improved. Upon completion of the process in step ST107, the controller 80 causes the processing to proceed to step ST108.

The controller 80 determines whether or not the remaining amount has fallen below the ordering threshold value (step ST108). For example, the controller 80 determines that the remaining amount has fallen below the ordering threshold value when the remaining amount value indicated by the remaining amount data D20 is smaller than the ordering threshold value of the setting data 92. When the controller 80 determines that the remaining amount has not fallen below the ordering threshold value (No in step ST108), the controller 80 causes the processing to proceed to step ST 111 to be described later.

When the controller 80 determines that the remaining amount has fallen below the ordering threshold value (Yes in step ST108), the controller 80 causes the processing to proceed to step ST109. The controller 80 starts an ordering process (step ST109). The ordering process includes, for example, a process of placing an order for the refill 210 of the measurement target object 200 via the communication module 60, and a process of placing an order for a new measurement target object 200 via the communication module 60. The ordering process includes, for example, a process of identifying the measurement target object 200 based on the ID of the weight data D10 and thereby determining the contents of the order. The ordering process includes, for example, a process of creating the order data D30 including information such as the contents of an order, a delivery destination, or the like. The ordering process includes, for example, a process of receiving a notification that the order has been confirmed from a transmission destination of the order data D30, and associating information indicating an order amount confirmed by the ordering with the order data D30. The ordering process includes, for example, a process of setting new weight data D10 after the ordering as an order amount confirmed by the ordering. Upon completion of the ordering process, the controller 80 causes the processing to proceed to step ST110.

The controller 80 adds the order amount confirmed by the ordering to the remaining amount data D20 (step ST110). For example, the controller 80 reflects the result of the ordering in the remaining amount data D20 by adding a value of the order amount confirmed by the ordering to the remaining amount data D20. Upon completion of the process in step ST110, the controller 80 causes the processing to proceed to step ST111.

The controller 80 determines whether or not a user operation has been performed (step ST111). For example, the controller 80 determines that a user operation has been performed when the controller 80 receives adjustment operation information from another electronic device or the like via the communication module 60. When the controller 80 determines that no user operation has been performed (No in step ST111), the controller 80 causes the processing to proceed to step ST113 to be described later. When the controller 80 determines that a user operation has been performed (Yes in step ST111), the controller 80 causes the processing to proceed to step ST112.

The controller 80 executes an adjustment process of adjusting the remaining amount data D20 (step ST112). The adjustment process includes, for example, a process of adjusting a remaining amount value indicated by the remaining amount data D20 based on the received. adjustment operation information. Upon completion of the adjustment process, the controller 80 causes the processing to proceed to step ST113.

The controller 80 determines whether or not the processing procedure shown in FIG. 15 has been completed (step ST113). For example, the controller 80 determines the completion of the processing procedure at a termination timing of the processing procedure. The termination timing includes, for example, a timing of termination of an ordering service, and a timing of generation of a termination request. When the controller 80 determines that the processing procedure has not been completed (No in step ST113), the controller 80 returns the processing back to step ST101 already described above and continues the processing procedure. When the controller 80 determines that the processing procedure has been completed (Yes in step ST113), the controller 80 terminates the processing procedure shown in FIG. 15.

In the processing procedure shown in FIG. 15, the process in step ST100 may be configured such that when the notification about the remaining amount of the measurement target object 200 is made from outside the weight measuring device 1, the notified value is set as the remaining amount data D20. Accordingly, the weight measuring device 1 can broaden available phases and/or types of the measurement target object 200 to be measured by the weight measuring device 1.

In the processing procedure shown in FIG. 15, the controller 80 functions as the calculator 81 by executing the processes in step ST103 to step S107. The controller 80 functions as the orderer 82 by executing the processes from step ST108 to step ST109.

As described above, the weight measuring device 1 can manage the remaining amount data D20 of the measurement target object 200 without being affected by a fluctuation in the weight sensor 30 because the weight measuring device 1 does not adjust the remaining amount data D20 when the weight data D10 measured by the weight sensor 30 is increased compared with the remaining amount data D20. Accordingly, the weight measuring device 1 can be prevented from erroneously placing an order based on the remaining amount data D20, and thus can improve the accuracy of ordering based on the weight data D10.

The weight measuring device 1 according to the variation described above can be varied so as to manage the remaining amount according to a user operation to the measurement target object 200.

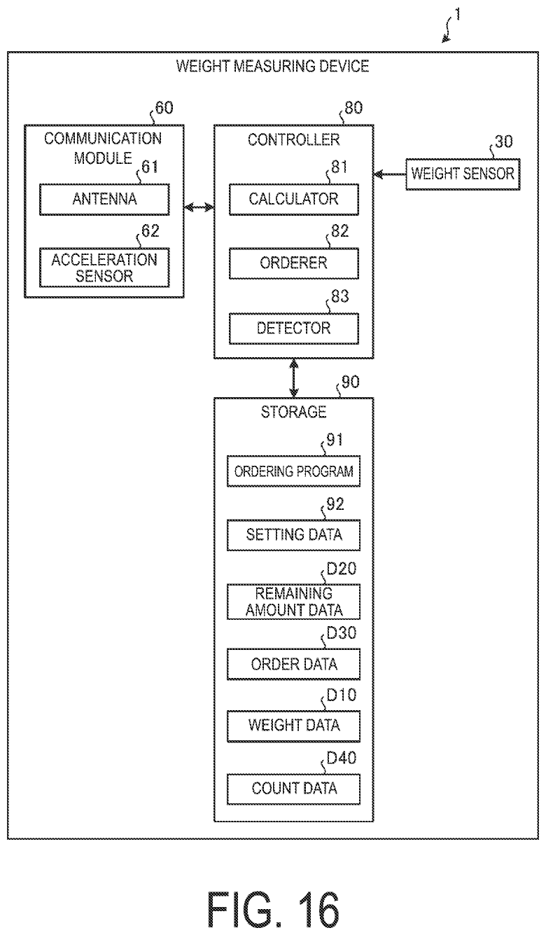

FIG. 16 is a block diagram illustrating a device configuration of the weight measuring device 1 according to another variation of an embodiment. The weight measuring device 1 includes the weight sensor 30 disposed in the weight measurer 10, the communication module 60 disposed in the communicator placement portion 50, the controller 80, and the storage 90.

The ordering program 91 in the storage 90 includes programs that cause the controller 80 to detect a use operation on the measurement target object 200, to adjust the remaining amount data D20 based on the weight data D 10 measured by the weight sensor 30 when the use operation has been detected, not to adjust the remaining amount data D20 when the use operation has not been detected, and to execute processing related to ordering of the measurement target object 200 based on the remaining amount data D20.

The storage 90 can also store count data D40. The count data D40 includes data indicating the number of times the use operation has been detected. For example, when the measurement target object 200 is hand soap, the count data D40 includes data indicating the number of times the push portion 201 has been pushed. That is, the use operation includes, for example, an operation to use the measurement target object 200. In the case of hand soap, the use operation is an operation of pushing the push portion 201 of the measurement target object 200. The count data D40 may include, for example, data indicating the number of changes in weight according to the pushing of the push portion 201. When the number of times of the use operation per use is recorded in the count data D40, the count data D40 can be used for analysis, machine learning, or the like of a feature and/or a use amount of a user when the user uses the measurement target object 200.

The weight data D10 in the storage 90 may include, for example, waveform data of a weight at a predetermined period within a predetermined time from the pushing of the push portion 201. As the predetermined time, for example, a time for the weight to stabilize after the use operation can be set. The predetermined time includes, fix example, a time period of a few seconds. Accordingly, the weight measuring device 1 can use the weight data D10 for machine learning in which the weight data D10 is used as a pattern of changes in weight according to use operations of the push portion 201.

The controller 80 includes functional units of the calculator 81, the orderer 82, and a detector 83. The controller 80 implements the calculator 81, the orderer 82, and the detector 83 by executing the ordering program 91.

The detector 83 can provide a function of detecting a use operation on the measurement target object. The detector 83 detects the use operation based on, for example, a change in the weight data D10 measured by the weight sensor 30. When the measurement target object 200 is hand soap, the use operation includes an operation of pushing the push portion 201. In this case, the weight data D10 measured by the weight sensor 30 indicates a pattern of changes according to the pushing. The detector 83 detects the use operation based on the pattern of changes in weight according to the pushing indicated by the weight data D10. The detector 83 stores the detection results of the use operations in the storage 90.

When the detector 83 detects the use operation, the calculator 81 implements a function of making an adjustment to the remaining amount data D20 based on the weight data D10 measured by the weight sensor 30. When the detector 83 detects no use operation, the calculator 81 implements a function of making no adjustment to the remaining amount data D20. The calculator 81 implements a function of activating the weight sensor 30 when the use operation is detected, adjusting the remaining amount data D20 based on the weight data D10 measured by the weight sensor 30, and then deactivating the weight sensor 30.

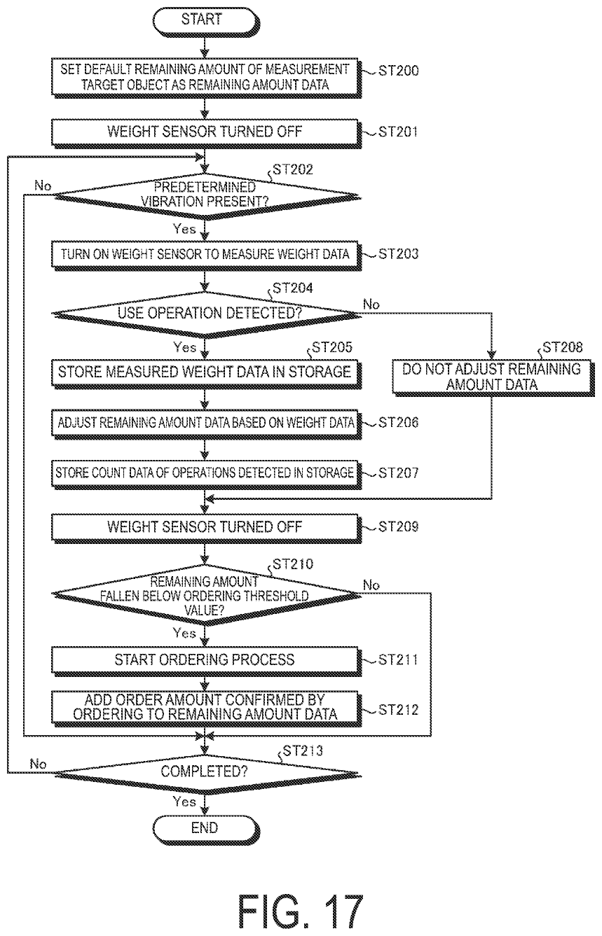

FIG. 17 is a flowchart showing an example of a processing procedure by the controller 80 of the weight measuring device 1 according to another variation of an embodiment. The processing procedure shown in FIG. 17 is implemented by the controller 80 executing the ordering program 91. The processing procedure shown in FIG. 17 is executed by the controller 80 at the predetermined timing described above.

As shown in FIG. 17, the controller 80 of the weight measuring device 1 sets a default remaining amount of the measurement target object 200 as the remaining amount data D20 (step ST200). The controller 80 turns off the weight sensor 30 (step ST201). Accordingly, the controller 80 reduces the power consumption in the weight measuring device 1 by not activating the weight sensor 30. Upon completion of the process in step ST201, the controller 80 causes the processing to proceed to step ST202.

The controller 80 determines whether or not a predetermined vibration has occurred (step ST202). For example, the acceleration sensor 62 of the weight measuring device 1 can measure an acceleration generated when a user performs a use operation on the measurement target object 200. Thus, when acceleration data measured by the acceleration sensor 62 shows a predetermined vibration, the controller 80 determines that the predetermined vibration has occurred. The predetermined vibration includes, for example, a vibration according to a use operation to the measurement target object 200. When the controller 80 determines that the predetermined vibration has not occurred (No in step ST202), the controller 80 causes the processing to proceed to step ST213 to be described later. When the controller 80 determines that the predetermined vibration has occurred (Yes in step ST202), the controller 80 causes the processing to proceed to step ST203.

The controller 80 turns on the weight sensor 30 to measure the weight data D10 (step ST203). For example, the controller 80 activates the weight sensor 30 whose power consumption has been suppressed and measures the weight data D10 with the weight sensor 30. Upon completion of the process in step ST203, the controller 80 causes the processing to proceed to step ST204.

The controller 80 determines whether or not a use operation has been detected (step ST204). For example, the controller 80 determines, based on weight data D10, that a use operation has been detected when the controller 80 detects changes in a weight during a few seconds after the detection of the predetermined vibration. When the controller 80 determines that a use operation has been detected (Yes in step ST204), the controller 80 causes the processing to proceed to step ST205.

The controller 80 stores the measured weight data D10 in the storage 90 (step ST205). For example, the controller 80 stores the weight data D10 of the weight sensor 30 in the storage 90 in chronological order. The controller 80 adjusts the remaining amount data D20 based on the weight data D10 (step ST206). For example, the controller 80 calculates a value of the remaining amount based on the weight data D10 and adjusts the remaining amount data D20 such that the remaining amount data D20 indicates the calculated value of the remaining amount. The controller 80 stores the count data D40 of the detected operations in the storage 90 (step ST207). For example, the controller 80 counts the number of operations by a user based on the weight data D10 and the acceleration data, and reflects the number of operations in the count data D40. Upon completion of the process in step ST207, the controller 80 causes the processing to proceed to step ST209 to be described later.

When the controller 80 determines that no use operation has been detected (No in step ST204), the controller 80 causes the processing to proceed to step ST208. The controller 80 does not adjust the remaining amount data D20 (step ST208). That is, since no use operation has been detected, the controller 80 does not reflect the weight data D10 in the remaining amount data D20. Upon completion of the process in step ST208, the controller 80 causes the processing to proceed to step ST209.

The controller 80 turns off the weight sensor 30 (step ST209). The controller 80 determines whether or not the remaining amount has fallen below the ordering threshold value (step ST210). For example, the controller 80 determines that the remaining amount has fallen below the ordering threshold value when the remaining amount value indicated by the remaining amount data D20 is smaller than the ordering threshold value of the setting data 92. When the controller 80 determines that the remaining amount has not fallen below the ordering threshold value (No in step ST210), the controller 80 causes the processing to proceed to step ST213 to be described later.

When the controller 80 determines that the remaining amount has fallen below the ordering threshold value (Yes in step ST210), the controller 80 causes the processing to proceed to step ST211. Similarly to step ST109 described above, the controller 80 starts an ordering process (step ST211). Upon completion of the ordering process, the controller 80 causes the processing to proceed to step ST212.

The controller 80 adds the order amount confirmed by the ordering to the remaining amount data D20 (step ST212). For example, the controller 80 reflects the result of the ordering in the remaining amount data D20 by adding a value of the order amount confirmed by the ordering to the remaining amount data D20. Upon completion of the process in step ST212, the controller 80 causes the processing to proceed to step ST213.

The controller 80 determines whether or not the processing procedure shown in FIG. 17 has been completed (step ST213). For example, the controller 80 determines the completion of the processing procedure at a termination timing of the processing procedure. The termination timing includes, for example, a timing of termination of an ordering service, and a timing of generation of a termination request. When the controller 80 determines that the processing procedure has not been completed (No in step ST213), the controller 80 returns the processing back to step ST202 already described above and continues the processing procedure. When the controller 80 determines that the processing procedure has been completed (Yes in step ST213), the controller 80 terminates the processing procedure shown in FIG. 17.

In the processing procedure shown in FIG. 17, the controller 80 functions as the calculator 81 by executing the processes in step ST204 to step ST208. The controller 80 functions as the orderer 82 by executing the processes in step ST210 to step ST211.

In the processing procedure shown in FIG. 17, the process in step SST208 may be changed, or a process may be added before and after step ST208. The process to be added includes, for example, a process of transmitting or storing the remaining amount data D20, data for debugging, data indicating the number of use operations per day, or the like to or in a server, a management device, or the like. This enables the weight measuring device 1 to support the analysis of a situation in which the remaining amount data D20 is not changed.

As described above, the weight measuring device 1 can manage the remaining amount of the measurement target object 200 without being affected by a fluctuation in the weight measuring device 1 because the weight measuring device 1 does not adjust the remaining amount data D20 when no use operation on the measurement target object 200 has been detected. Accordingly, the weight measuring device 1 can be prevented from erroneously placing an order based on the remaining amount data D20, and thus can improve the accuracy of ordering based on the weight data D10.

In the above variation, the weight measuring device 1 implements both of the calculator 81 and the orderer 82, but is not limited thereto. For example, the weight measuring device 1 may be configured to cause a cooperating cloud server or the like to execute the functions of the calculator 81 or the orderer 82.

The ordering system 1000 according to the above embodiments and the weight measuring device 1 according to the above variations automatically place an order for the measurement target object 200 using the weight data D10, but are not limited thereto. For example, the ordering system 1000 and the weight measuring device 1 may be configured to perform ordering by executing, as processing related to ordering, a process of prompting a user, an administrator, or the like to place an order.

In the ordering system 1000 according to the above embodiments and the weight measuring device 1 according to the above variations, the weight sensor 30 and the acceleration sensor 62 are described as examples of a sensor for detecting a use operation. However, the weight measuring device 1 may include another sensor as a sensor for detecting a use operation. The weight measuring device 1 may use, for example, an infrared sensor, a proximity sensor, a Time of Fight (Tor) camera, a Light Detection and Ranging (LIDAR), or a camera as a sensor for detecting a use operation. Specifically, the weight measuring device 1 may use an infrared sensor, a proximity sensor, a ToF camera, LIDAR, a camera, a microphone, or the like. When the weight measuring device 1 determines that a user has not been continuously present in the vicinity of the weight measuring device 1 for a predetermined time period based on information acquired by an infrared sensor, a proximity sensor, a ToF camera, LIDAR, or a camera, the weight measuring device 1 may consider that the weight measuring device 1 has not been used (in other words, the weight measuring device 1 has detected no use operation). When the weight measuring device 1 determines that a user has been continuously present in the vicinity of the weight measuring device 1 for a predetermined time period based on information acquired by an infrared sensor, a proximity sensor, a ToF camera, LIDAR, or a camera, the weight measuring device 1 may consider that the weight measuring device 1 has been used (in other words, the weight measuring device 1 has detected a use operation).

The weight measuring device 1 may use, for example, a microphone as a sensor for detecting a use operation. Specifically, when the weight measuring device 1 has not acquired user's sound equal to or higher than a predetermined level from the microphone, the weight measuring device 1 may consider that the weight measuring device 1 has not been used (in other words, the weight measuring device 1 has not detected a use operation). When the weight measuring device 1 has acquired a user's sound equal to or higher than a predetermined level from the microphone, the weight measuring device 1 may consider that the weight measuring device 1 has been used (in other words, the weight measuring device 1 has detected a use operation). When the weight measuring device 1 has not acquired a certain sound (a sound of water running from a faucet or the like) from the microphone, the weight measuring device 1 may consider that the weight measuring device 1 has not been used (in other words, the weight measuring device 1 has not detected a use operation). When the weight measuring device 1 has acquired a certain sound (a sound of water running from a faucet or the like) from the microphone, the weight measuring device 1 may consider that the weight measuring device 1 has been used (in other words, the weight measuring device 1 has detected a use operation).

The weight measuring device 1 may include a plurality of sensors described above as sensors for detecting a use operation, and determine whether or not a use operation has been detected using the plurality of sensors.

The weight measuring device 1 may be configured to cause a cooperating cloud. server or the like to execute the function of determining whether or not a use operation of the weight measuring device 1 has been detected. For example, the cloud server may receive information of the above-described sensor for detecting a use operation from the weight measuring device 1, and the cloud server may detect a use operation of the weight measuring device 1 based on the received information.

Embodiments have been described in order to fully and clearly disclose the technology according to the appended claims. However, the appended claims are not to be limited to the embodiments described above, and should be configured to embody all modifications and alternative configurations that those skilled in the art may make within the underlying matter set forth herein.

### REFERENCE SIGNS

1 Weight measuring device
10 Weight measurer
11 Weight measurer body
30 Weight sensor
40 Tray
50 Communicator placement portion
60 Communication module
61 Antenna
62 Acceleration sensor
80 Controller
90 Storage
91 Ordering program
92 Setting data
200 Measurement target object
201 Push portion
300 Ordering device
330 Communicator
340 Storage
341 Ordering program
342 Setting data
350 Controller
351 Calculator
352 Orderer
353 Setter
354 Adder
1000 Ordering system
D10 Weight data
D20 Remaining amount data
D30 Order data
D40 Count data

1. An ordering system comprising:
a weight measuring device configured to transmit weight data to outside, the weight data obtained by measuring a weight of a measurement target object; and
an ordering device configured to acquire the weight data transmitted by the weight measuring device,
the ordering device comprising:
a storage configured to store remaining amount data of the measurement target object, the remaining amount data indicating a weight of the measurement target object measured after the measurement target object is used or after the measurement target object is refilled; and
a calculator configured to adjust the remaining amount data based on the weight data when the weight data is less than the remaining amount data and to maintain the remaining amount data when the weight data is more than the remaining amount data; and
an orderer configured to execute processing related to ordering of the measurement target object based on the remaining amount data.

2. The ordering system according to claim 1, wherein
the weight measuring device further comprises:
at least one sensor configured to acquire information indicating an operation of the measurement target object; and
a transmitter configured to transmit the information indicating the operation and the weight data to the outside,
the calculator is further configured to determine, based on the information indicating a use operation, whether or not to adjust the remaining amount data based on the weight data.

3. The ordering system according to claim 2, wherein
the at least one sensor comprises an acceleration sensor configured to detect a vibration of a container containing the measurement target object,
the transmitter is further configured to transmit detection count data to outside, the detection count data indicating a number of detections of the vibration detected by the acceleration sensor, and
the calculator of the ordering device is further configured to adjust the remaining amount data based on the weight data when a number of detections satisfies a judgment criterion and not to maintain the remaining amount data when the number of detections does not satisfy the judgment criterion.

4. The ordering system according to claim 3, wherein
the ordering device further comprises a setter configured to set the weight data as an initial value of the remaining amount data in the storage, the weight data acquired at a start of using the measurement target object.

5. The ordering system according to claim 4, wherein
the ordering device further comprises an adder configured to add an order amount of the measurement target object ordered by the orderer to the remaining amount data.

6. A weight measuring device comprising:
a weight sensor configured to measure weight data of a measurement target object;
a storage configured to store remaining amount data of the measurement target object, the remaining amount data indicating a weight of the measurement target object measured after the measurement target object is used or after the measurement target object is refilled;
a calculator configured to adjust the remaining amount data based on the weight data when the weight data is less than the remaining amount data and to maintain the remaining amount data when the weight data is more than the remaining amount data; and
an orderer configured to execute processing related to ordering of the measurement target object based on the remaining amount data.

7. The weight measuring device according to claim 6 further comprising:
an acceleration sensor configured to detect a vibration of a container containing the measurement target object, wherein
the calculator is further configured to adjust the remaining amount data based on the weight data when a number of detections of vibration satisfies a judgment criterion and to maintain the remaining amount data when the number of detections does not satisfy the judgment criterion, the number of detections of vibration detected by the acceleration sensor.

8. A weight measuring device comprising:
a weight sensor configured to measure weight data of a measurement target object;
a storage configured to store remaining amount data of the measurement target object;
a detector configured to detect an use operation on the measurement target object; and
a calculator configured to determine, according to the use operation detected, whether or not to adjust the remaining amount data based on the weight data measured by the weight sensor, the remaining amount data indicating a weight of the measurement target object measured after the measurement target object is used or after the measurement target object is refilled.

9. The weight measuring device according to claim 8, further comprising:
an orderer configured to execute processing related to ordering of the measurement target object based on the remaining amount data, wherein
the calculator is further configured to adjust the remaining amount data based on the weight data measured by the weight sensor when the operation has been detected and to maintain the remaining amount data when the operation has not been detected.

10. The weight measuring device according to claim 8, wherein
the detector is further configured to store count data indicating a number of detections of the operation in the storage.

11. The weight measuring device according to claim 10, wherein
the calculator is further configured to activate the weight sensor when the operation has been detected, adjust the remaining amount data based on the weight data measured by the weight sensor, and then deactivate the weight sensor.
